(19) United States
(12) Patent Application Publication
(10) Pub. No.: US 2007/0136988 A1
(43) Pub. Date: Jun. 21, 2007

(54) Hinge

(76) Inventor: Mark Alan Bullock, Bossier City, LA (US)

Correspondence Address: CHRISTOPHER D. HARRINGTON, SUITE 350, 5300 CORPORATE GROVE SE, GRAND RAPIDS, MI, 49512, US

(21) Appl. No.: 11/294,056

(22) Filed: Dec. 5, 2005

(51) Int. Cl. E05D 7/04

(52) U.S. Cl. 16/245

(57) ABSTRACT

A novel overlay hinge for interconnection of a door and a frame of a cabinet and for operation between an open position and a closed position, the invention comprising a cup portion for mounting to the door and a hinge arm with one end pivotably connected to the cup portion and the other end is slideably coupled to a fastener plate, where the fastener plate is attachable to the frame of the cabinet. The fastener plate further comprises a first semi-planar surface for contact with the f lame and a second planar surface for slideable engagement with the hinge arm, the hinge arm including at least one pair of laterally aligned and opposed retainer bosses for engaging the second semi-planar surface. The fastener plate being interconnected to the hinge arm end by a cam screw that is affixed at one end to the second semi-planar surface and which is adjustable rotateable at the other end in an elongated slot in the hinge arm. The first and second semi-planar surfaces being interconnected by a web that allows for an elastically resilient connection at one end, and where the first and second semi-planar surfaces are interconnected by an adjusting screw at the other end for horizontally arcing movement relative to each of said semi-planar surfaces. The fastener plate including an elongate aperture in the first semi-planar surface for adjustable affixation of the hinge arm to the frame.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a new hinge for furniture products. More particularly, the present invention relates to a compact overlay hinge that is used primarily for mounting doors onto a cabinet.

Furniture hinges have evolved in the last thirty years to become smaller in size, easier to install and adjust, and with increased functionality such as providing a self-closing force to a door, or quick disconnection between a door and a cabinet. One of the types of hinges that has become very popular in this regard is termed a “compact” hinge for the reason that it relatively moderate in size, but also because it can be installed between a door and a cabinet in a way that is very unobtrusive.

Compact hinges of the type discussed herein, are typified by a cup portion that mounts into a recess cut into a door, and an arm portion that is pivotably connected to the cup portion and is also mounted to a portion of the cabinet. Examples of compact hinges may be seen, for example, in U.S. Pat. No. 5,617,612 to Ferrari, in U.S. Pat. No. 5,604,956 to Grass, in U.S. Pat. No. 6,647,591 to Domenig, and in U.S. Pat. No. RE 34,995 which is a re-exam patent (U.S. Pat. No. 5,175,908) to Domenig. The hinges in this group may sometimes be referred to as “overlay” hinges owing to the fact that the hinge supports the door in a manner in which the door overlays the opening in the cabinet, rather than the situation where the door is mounted within the opening.

The hinges of the prior art are typified by an amazingly complex integration of parts and sub-assemblies that work together to achieve the desired functionality. The manual labor, however, that is required to manufacture such hinges is very substantial given the relatively low cost of the final product. This fact alone usually dictates that the manufacture of such hinges must be done under conditions of low labor cost and/or highly automated manufacturing. Before now, there has been no real alternative to the hinge design that would admit to a lower cost for assembly or that would comprise a less complex grouping of components.

The difficulties in overcoming the problems of the prior art are very significant since the compact hinge performs multiple tasks. The hinge arm is not only responsible for retaining the door to the frame of the cabinet, but it also provides adjustability with regards to the distance the door is held from the cabinet frame, and also as to the angle at which the door meets the surface of the cabinet frame. The compact hinge design also includes a spring action for biasing the door to a closing position and this bias can be enhanced with stopping points where the door will be maintained in an open position when needed and once the closing of the door is commenced, the closing bias is recommenced. All of these functions are resident in the relatively small cluster of components that make up the compact hinge, and while it has always been desirable to reduce the number of components for the purposes of cost reduction and for ease of manufacturing, it has also been a concurrent requirement to retain the complete functionality of the hinge.

The prior art hinge designs, as elegant and as highly developed as they are, still fall short when it comes to the difficulties associated with the assembly of such complex hardware and the need to keep the costs of such hinges competitive. Thus it is that with the presentation of the present invention such problems as have been experienced in the prior art have been eliminated or minimized.

### SUMMARY OF THE INVENTION

A novel compact hinge of the present invention comprises a cup portion for mounting in a door and a hinge arm that is pivotably connected to the boss portion by means of a hinge pin. The hinge arm includes a hinge arm top plate that is slideably coupled to a fastener plate, where the fastener plate is attachable to the frame of a cabinet. The fastener plate and the hinge arm top plate are in adjustable relation to each other by a cam screw for adjustment in a direction perpendicular to the axis of the hinge pin, and also where the fastener plate includes a top and a bottom that are adjustable in a radial direction with respect to each other and when coupled with the hinge arm top plate results in concurrent adjustment of the angle of the hinge arm with respect to the bottom of the fastener plate.

The compact hinge of the present invention includes a fastener plate that uniquely provides a first semi-planar surface for contact with the frame of a cabinet, and a second semi-planar surface for engagement with the hinge arm top plate, where both the first semi-planar surface and the second semi-planar surface are interconnected by a web extending between corresponding ends of each of said semi-planar surfaces and where the web is elastically flexible and allows the distance between the first semi-planar surface and the second semi-planar surface to be selectively adjusted.

The compact hinge of the present invention also uniquely includes a hinge arm top plate that has retainer projections that are laterally aligned along the each of the hinge arm top plate sidewalls and which alignably engage a corresponding slot in the fastener plate thereby retaining the fastener plate to the hinge arm top plate when both are in the engaged orientation. Further, the hinge arm top plate and the fastener plate are fastened to each other by means of a cam screw.

These and other features and benefits of the present invention will be discussed in more detail below.

### BRIEF DESCRIPTION OF THE DRAWINGS

FIG. 1 is a top plan view of the compact hinge of the present invention.

FIG. 2 is a rear isometric view of the compact hinge of FIG. 1.

FIG. 3 is a side elevation view of the compact hinge of FIG. 1.

FIG. 4 is a side elevation view of the hinge arm assembly of the compact hinge of the present invention.

FIG. 5 is an isometric view of the hinge arm assembly of the compact hinge of the present invention, showing the fastener plate as engaged with the hinge arm top plate.

FIG. 6 is an isometric view of the fastener plate of the hinge arm assembly as shown in FIG. 5.

FIG. 7 is an isometric view of the hinge arm of FIG. 5 without the fastener plate.

FIG. 8 is an exploded isometric view of the hinge arm assembly of the present invention as viewed from the bottom side.

FIG. 9 is an exploded isometric view of the hinge arm assembly of the present invention as viewed from the topside.

FIG. 10 is an exploded isometric view of the compact hinge of the present invention.

### DETAILED DESCRIPTION OF THE PREFERRED EMBODIMENTS

A new compact hinge for installation between a door and a frame of a furniture article is shown in the drawings. The new compact hinge is typically installed on cabinet type furniture, although it may be used in a number of applications where a door is to be secured to the frame of a furniture article by means of a hinge. The hinge is considered to be of the “overlay” type which means that the door of the cabinet will overlay the opening in the cabinet. The compact hinge is designed to be concealed from view when the door is closed in applications of this type, yet it is desired to maintain the door in an aligned position for cosmetic purposes, but also for purposes of closing correctly, i.e., leaving no gaps and avoiding undue impacts between the door and the face of the frame from the self-closing action. For purposes of discussion herein, the references to the installation of the compact hinge will be made to its use on a cabinet although it is understood that such reference is not limiting in terms of the applications of use of the present invention.

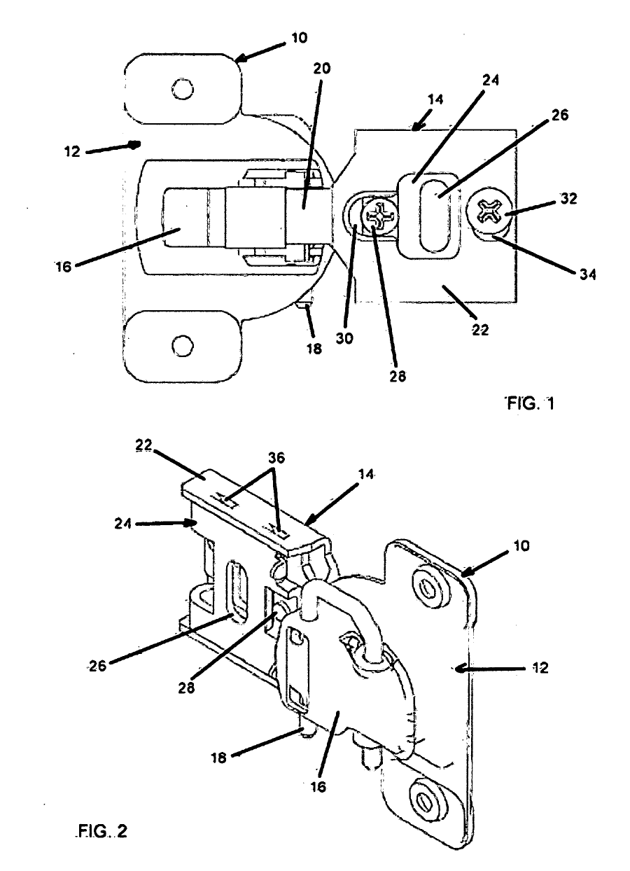

Turning to FIGS. 1 and 2, the compact hinge 10 is shown with the cup portion 12 and the hinge arm 14. The cup portion 12 further include the cup 16 and the hinge pin 18. The cup portion 12 includes other features which are not discussed with particularity but which are essentially common or analogous to many of components of the prior art compact hinges disclosed above. As such, the balance of the features of the cup portion 12 will not be specified since the present invention relates to the hinge arm assembly, but it is understood that the cup portion 12 is required to complete the invention and to therefore form a complete compact hinge device.

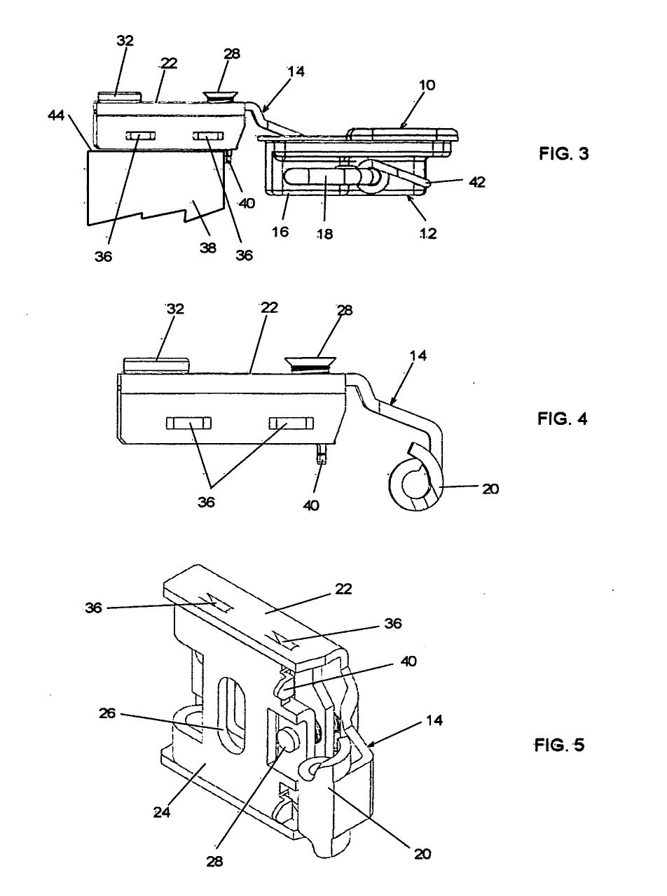

The hinge arm 14 extends from the cup portion 12 and is interconnected to the cup portion by means of the hinge pin 18. The hinge arm 14 is an assembly of components that includes the hinge arm pivot end 20, the hinge arm top plate 22, and the fastener plate 24. The fastener plate 24 includes the fastener aperture 26. The hinge arm top plate 22 includes the elongate opening 30 and the cam adjustment opening 34 and the top plate bosses 36. Also shown are the adjusting screw 28 and the cam screw 32. With respect to FIGS. 3, 4 and 5, the fastener plate flange(s) 40 can be seen as well as the hinge spring 42. In addition, a portion of the frame 38 of a cabinet is shown with the frame edge 44.

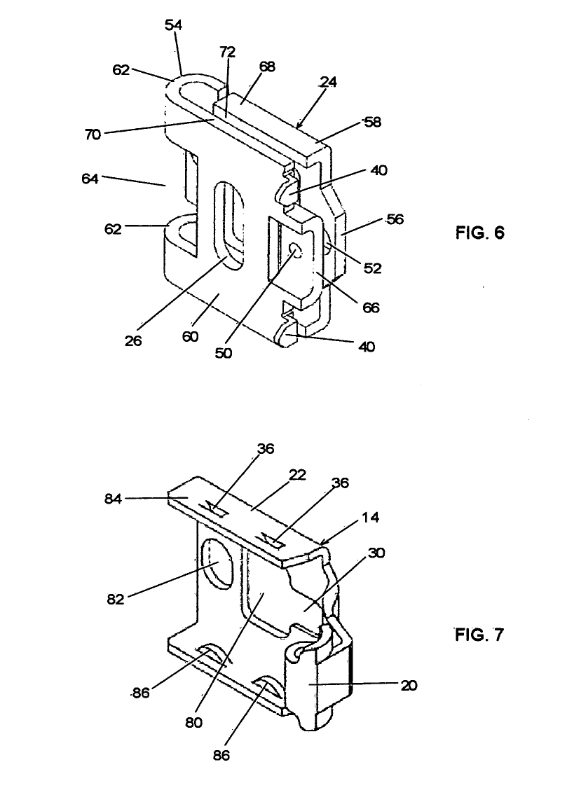

Details of the hinge arm assembly are disclosed in FIGS. 6 and 7, with the fastener plate 24 shown with the adjusting screw mounting hole 50, the adjusting screw threaded hole 52, the fastener plate front 54, the fastener plate rear 56, the fastener plate top 58, the fastener plate bottom 60, the fastener plate web(s) 62, the web gap 64, the adjusting screw boss 66, the fastener plate sidewalls 68, the fastener plate bottom edge 70 and the fastener plate slot 72. With respect to the hinge arm 14, features include the hinge arm aperture 80, the cam screw aperture 82, the hinge arm sidewalls 84 and the hinge arm retainers 86, which retainers are the inner projections from the bosses 36.

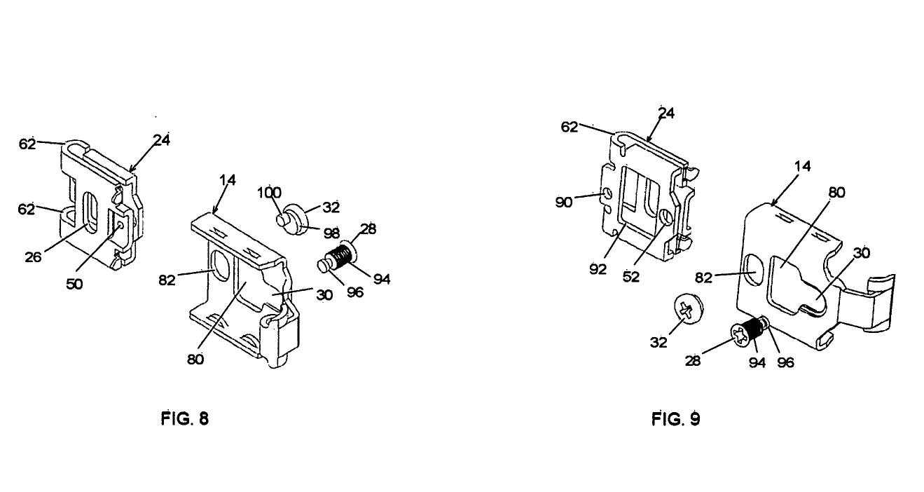

FIGS. 8, 9 and 10 reveal a few additional features of the hinge arm assembly, including the cam screw base aperture 90 and the fastener plate top opening 92. In general, the features of the hinge arm assembly can be seen in comparison from the opposing isometric views and with respect to the exploded view of the compact hinge in

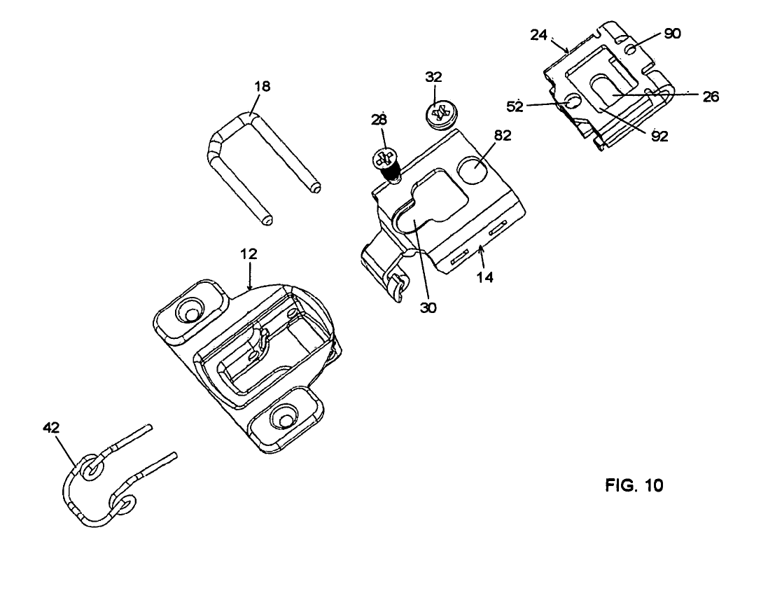

FIG. 10. The adjusting screw 28 is seen with adjusting screw threads 94 and adjusting screw base 96. Similarly, the cam screw 32 is seen with the cam face 98 and the cam screw base 100.

The installation of the compact hinge typically requires that the cup portion 12 be fitted into a routed bore opening in the door of the cabinet. This can be a tight fit although the cup portion is secured to the door by screws. The hinge arm assembly is attached to the cup portion 12 at the hinge pin 18 and this attachment allows the hinge arm 14 to rotateably operate around the hinge pin 18 and to move the hinge arm 14 from a closed position to an open position. In the drawings, the hinge arm 14 is shown in the open position only, however reference to the prior art shows the operational aspects of the hinge arm 14 which are the equivalent to that of the present invention. The hinge arm assembly provides adjustability for the compact hinge to control the distance between the inside of the cabinet door and the face of the cabinet frame as may be seen in FIGS. 1 through 4 of U.S. Pat. No. 6,647,591 to Domenig. The three dimensional adjustability of the '591 hinge is described at Column 9, lines 24 through 41 in the reference. The adjustments are identified as up-and-down (vertical) which is achieved through the usage of the fastening screw (117) in the elongated center hole (122) in the base hinge arm segment (120). The side-to-side adjustment is identified as being achieved through the turning of the adjustment screw (113) causing intermediate hinge arm segment (140) to move in a horizontally arcing manner allowing the desired spacing/adjustments of the doors from the opposite sides of the cabinet door openings. Lastly, the cam screw (114) causes the base hinge arm segment (120) to move relative to the intermediate hinge arm segment (130) in a horizontal in-and-out direction.

The three dimensional adjustment movements described above are replicated in the present invention although through a very different mechanism. For the purposes of the present discussion regarding the three dimensional adjustments of the compact hinge, the terminology used in the '591 reference is repeated herein as the up-and-down, the side-to-side, and the in-and-out adjustments when referring to the analogous adjustment found in the present invention.

The focus in the present invention is on the new way that the three dimensional adjustment is achieved in the compact hinge. The fastener plate 24 engages the hinge arm top plate 22 when the hinge arm retainers 86 are aligned with the fastener plate slots 72. These features are paired on each side of the respective plates and as may be appreciated from the drawings, the fastener plate 24 is able to slide into an installed and engaged position in the hinge arm top plate 22 when this alignment is made. In this position, the fastener plate 24 is slideably held by the retainers 86 and except for the cam screw 32, the fastener plate 24 can slide in and out of the hinge arm top plate 22. The cam screw base 100 is peened over once the hinge arm assembly is together, thus keeping the cam screw 32 affixed to the fastener plate 24 but allowing it to rotate in this position when turned. The cam screw 32, when turned, will see the cam face 98 work against the edge of the cam screw aperture 82 in the hinge arm top plate 22. Since the cam screw base 100 is engaged with the cam screw base aperture 90 which is located on the fastener plate 24, the eccentric action of the cam face 98 on the cam screw aperture 82 will generate the in-and-out adjustment as between the door and the frame (per the usual installation). This is the case even though there is no independently slideable intermediate structure in between the hinge arm top plate 22 and the fastener plate 24 as has been known in the prior art.

The fastener plate 24 is fundamentally different from the components that have been used in the prior art, since it is comprised of an integrally formed one-piece construction that is folded over to form the fastener plate top 58 and the fastener plate bottom 60 which are connected by the fastener plate web 62. The web 62 is comprised of the integrally formed bend at the front 54 of the fastener plate 24. Part of the bend has been removed leaving the fastener plate gap 64 between the remaining metal portions that comprise the web 62. This arrangement allows the fastener plate top 58 and the fastener plate bottom 60 to be resiliently and elastically adjustable as between each other, in what may be described as a horizontally arcing movement. The web 62 provides enough mechanical strength to maintain the structure of the fastener plate 24, however with the elimination of a sufficient amount of metal represented by the gap 64, the web 62 becomes elastically bendable about a rotational axis roughly centered at the apex of the bend of the web and which is parallel to the rotational axis of the hinge pin 18. This radial flexibility of the fastener plate top 58 relative to the fastener plate bottom 60 imparts the freedom to the hinge arm assembly to react in the adjustment direction described above as the side-to-side adjustment.

The actual side-to-side adjustment is achieved mechanically through the use of the adjusting screw 28 which has adjusting screw threads 94 threadably engaged with the adjusting screw threaded hole 52 and with adjusting screw base 96 rotateably affixed to the adjusting screw mounting hole 50. The adjusting screw base 96 has an end that is reduced where it meets with the circumference of the adjusting screw mounting hole 50 but is expanded at the very end in order to retain it to the fastener plate 24. The adjusting screw mounting hole 50 is located on the adjusting screw boss 66 which is a raised area on the fastener plate bottom 60. The boss 66 is needed to provide clearance for the adjusting screw base 96 which extends below the boss 66 and needs to remain above the surface on to which the fastener plate 24 is being mounted. Rotation of the adjusting screw 28 will therefore cause the adjusting screw threads 94 to raise or lower the fastener plate top 58 relative to the fastener plate bottom 60 by the action on the adjusting screw threaded hole 52. Since the position of the adjusting screw 28 is towards the fastener plate rear 56, the end result is a rotation of the fastener plate top 58 relative to the fastener plate bottom 60 about a radius that is, as mentioned above, located somewhat in the vicinity of the apex of the bend exhibited by the web 62.

In operational terms, the fastener plate top 58 and the fastener plate bottom 60 each represent semi-planar surfaces, one surface cooperating with installation on to the edge of a frame (in the usual application) and the other semi-planar surface cooperating with engagement with the hinge arm top plate 22. As may be inferred from the drawings, the fastener plate bottom 60 is the feature of the fastener plate 24 that rests on the surface to which the fastener plate 24 is to be mounted. In the at-rest position, the semi-planar surfaces are parallel to each other, however, when the adjusting screw 28 is turned, each of the semi-planar surfaces will be at angles to each other, and such angles can be acute or obtuse from the point of view of the rotational axis of the fastener plate 24. This movement of one semi-planar surface to the other, is imparted to the hinge arm top plate 22 and therefore to the hinge arm 14 by means of the engagement of the fastener plate 24 with the retainers 86. Thus when the hinge arm assembly is affixed to a stationary point, such as the edge of a frame, the side-to-side adjustment between the frame and the door (which is affixed to the cup portion 12) is realized.

The last adjustment function relates to the up-and-down adjustment which results from the vertical displacement of the hinge arm assembly on the surface to which it is mounted. Again, using the frame edge as the usual example, the fastener plate 24 is placed onto the frame edge and is guided in its placement by means of the fastener plate flanges 40 which contact the corner where the frame and the frame edge meet. This helps to ensure that the hinge is being installed in a substantially square orientation. The fastener plate 24 includes the fastener aperture 26 which is an elongate opening that is sized to receive a screw (not shown) that is capable of fastening the hinge to the frame. The fastener aperture 26 is vertically elongated, its axis of elongation being parallel to the axis of rotation of the hinge pin 18. This allows the fastener plate 24 to be vertically adjusted in accordance with the clearance provided between the fastener aperture 26 and the screw when the screw is less than fully secured to the frame. This adjustment is essentially the same adjustment method as has been employed on many of the prior art hinges and reference is made to those hinges with respect to the installation techniques and possible variations.

Thus it can be understood that a three-dimensional adjustment ability is imparted to the compact hinge of the present invention, the adjustment ability gained through the use of a novel approach for securing the hinge arm 14 to a frame of a cabinet. The benefits of the present invention include the fact that less component parts are needed to obtain the same functionality, specifically; there is no independent intermediate structure between the hinge arm and the component part that becomes attached to the cabinet frame. In addition, there is no hinge pin needed to couple the hinge arm and any various mounting plates or intermediate plates.

It should be noted that the installation orientation with the cup portion 12 fitted into a bore opening on the door of a cabinet and the hinge arm assembly fitted on to the frame of a cabinet, could be reversed even though this is not the usual practice. In addition, the compact hinge of the present invention may be used in other application that require a hinge treatment, including furniture, overhead flipper doors mounted on shelves, and the like.

The teachings herein are meant to illustrate the invention and the possible uses it may provide. The examples and discussions are not intended to unduly limit the scope of the invention and it is asserted that variations that can be reasonably extrapolated from the teachings herein are still within the scope and spirit of the invention.

I claim:

1. An overlay hinge for mounting a door to a frame in a cabinet, for movement between an open and a closed position of the door, the overlay hinge being adjustable for the fit between the door and the frame, the hinge comprising;
A cup portion for mounting the hinge onto the door of the cabinet;
A hinge arm pivotably fastened to the cup portion at one end;
A fastener plate engaged with the other end of said hinge arm and where the fastener plate is fastenable to the cabinet frame;
A cam screw;
An adjusting screw; and,
Wherein said fastener plate comprises a first semi-planar surface for contact with the frame of the cabinet and a second semi-planar surface for slideable engagement with the hinge arm, the first semi-planar surface further containing an aperture for receiving a fastener for mounting the fastener plate to the frame, and where the second semi-planar surface is aligned above said first semi-planar surface and where the two are elastically interconnected by a web, and where the adjusting screw is fixed to the first semi-planar surface and is adjustably connected to the second semi-planar surface and when the adjusting screw is rotated the first semi-planar surface and the second semi-planar surface move in a horizontally arcing direction relative to each other and about an axis defined by the web interconnecting the two and producing a side-to-side adjustment with respect to the door and frame, and where the slideable engagement of the second semi-planar surface with the hinge arm is by an opposed pair of laterally oriented retainer bosses extending from said hinge arm, and where the hinge arm includes an elongate opening for the receipt of the cam screw with the cam screw interconnecting the hinge arm and the second semi-planar surface and upon the rotation of the cam screw the fastener plate moves in a longitudinal direction relative to the hinge arm producing an in-and-out adjustment with respect to the door and frame.

2. The hinge of claim 1, where the aperture in the first semi-planar surface is elongated and when the fastener has not fully affixed the fastener plate to the frame, the fastener plate is adjustable within the range of said elongated hole producing and up and-down adjustment with respect to the door and the frame.

3. The hinge of claim 1, where the hinge arm includes two pairs of opposed laterally oriented retainer bosses extending from said hinge arm.

4. The hinge of claim 1, where the web interconnecting the first semi-planar surface and the second semi-planar surface includes a gap for controllably imparting elastic resilience to the movement between the first semi-planar surface and the second semi-planar surface.

5. An overlay hinge for mounting a door to a frame in a cabinet, for movement between an open and a closed position of the door, the overlay hinge being adjustable for the fit between the door and the frame , the hinge comprising;
A cup portion for mounting the hinge onto the door of the cabinet;
A hinge arm pivotably fastened to the cup portion at one end;
A fastener plate engaged with the other end of said hinge arm and where the fastener plate is fastenable to the cabinet frame;
A cam screw;
An adjusting screw; and,
Wherein said fastener plate comprises a first semi-planar surface for contact with the frame of the cabinet and a second semi-planar surface for slideable engagement with the hinge arm, the first semi-planar surface further containing an aperture for receiving a fastener for mounting the fastener plate to the frame where said aperture is elongated and when the fastener has not fully affixed the fastener plate to the frame, the fastener plate is adjustable within the range of said elongated hole producing and up-and-down adjustment with respect to the door and the frame, and where the second semi-planar surface is aligned above said first semi-planar surface and where the two are elastically interconnected by a web, and where the adjusting screw is fixed to the first semi-planar surface and is adjustably connected to the second semi-planar surface and when the adjusting screw is rotated the first semi-planar surface and the second semi-planar surface move in a horizontally arcing direction relative to each other and about an axis defined by the web interconnecting the two and producing a side-to-side adjustment with respect to the door and frame, and where the slideable engagement of the second semi-planar surface with the hinge arm is by an opposed pair of laterally oriented retainer bosses extending from said hinge arm, and where the hinge arm includes an elongate opening for the receipt of the cam screw with the cam screw interconnecting the hinge arm and the second semi-planar surface and upon the rotation of the cam screw the fastener plate moves in a longitudinal direction relative to the hinge arm producing an in-and-out adjustment with respect to the door and frame.

6. The hinge of claim 5, where the hinge arm includes two pairs of opposed laterally oriented retainer bosses extending from said hinge arm.

7. The hinge of claim 5, where the web interconnecting the first semi-planar surface and the second semi-planar surface includes a gap for controllably imparting elastic resilience to the movement between the first semi-planar surface and the second semi-planar surface.

8. An overlay hinge for mounting a door to a frame in a cabinet, for movement between an open and a closed position of the door, the overlay hinge being adjustable for the fit between the door and the frame, the hinge comprising;
A cup portion for mounting the hinge onto the door of the cabinet;
A hinge arm pivotably fastened to the cup portion at one end;
A fastener plate engaged with the other end of said hinge arm and where the fastener plate is fastenable to the cabinet frame;
A cam screw;
An adjusting screw; and,
Wherein said fastener plate comprises a first semi-planar surface for contact with the frame of the cabinet and a second semi-planar surface for slideable engagement with the hinge arm, the first semi-planar surface further containing an aperture for receiving a fastener for mounting the fastener plate to the frame where said aperture is elongated and when the fastener has not fully affixed the fastener plate to the frame, the fastener plate is adjustable within the range of said elongated hole producing and up-and-down adjustment with respect to the door and the frame, and where the second semi-planar surface is aligned above said first semi-planar surface and where the two are elastically interconnected by a web, and where the adjusting screw is fixed to the first semi-planar surface and is adjustably connected to the second semi-planar surface and when the adjusting screw is rotated the first semi-planar surface and the second semi-planar surface move in a horizontally arcing direction relative to each other and about an axis defined by the web interconnecting the two and producing a side-to-side adjustment with respect to the door and frame.

9. The hinge of claim 8, where the slideable engagement of the second semi-planar surface with the hinge arm is by an opposed pair of laterally oriented retainer bosses extending from said hinge arm, and where the hinge arm includes an elongate opening for the receipt of the cam screw with the cam screw interconnecting the hinge arm and the second semi-planar surface and upon the rotation of the cam screw the fastener plate moves in a longitudinal direction relative to the hinge arm producing an in-and-out adjustment with respect to the door and frame.

10. The hinge of claim 8, where the hinge arm includes two pairs of opposed laterally oriented retainer bosses extending from said hinge arm.

11. The hinge of claim 8, where the web interconnecting the first semi-planar surface and the second semi-planar surface includes a gap for controllably imparting elastic resilience to the movement between the first semi-planar surface and the second semi-planar surface.
